(19) United States
(12) Patent Application Publication
(10) Pub. No.: US 2026/0301043 A1
(43) Pub. Date: Oct. 1, 2026

(54) INTEREST DECAY AND MIGRATION ANALYSIS FOR CONTENT RECOMMENDATION

(71) Applicant: Google LLC, Mountain View, CA (US)

(72) Inventor: Youming Liu, San Jose, CA (US)

(21) Appl. No.: 19/089,532

(22) Filed: Mar. 25, 2025

(51) Int. Cl. G06Q 30/0601

(52) U.S. Cl. CPC G06Q 30/0631

(57) ABSTRACT

Disclosed implementations for content recommendation. In an example implementation, a current entity of interest is determined based on interaction data associated with a period of time. A next entity of interest and a transition timeframe is determined based on the current entity, the period of time, and a plurality of interest movement patterns. Each interest movement pattern of the plurality of interest movement patterns is associated with a respective entity pair and a respective transition time. The respective transition time and the respective entity pair being identified from user interaction histories. A recommended content item is identified based on the current entity of interest and the next entity of interest, The recommended content item is provided based on the transition timeframe.

### BACKGROUND

A content recommendation system is a tool that analyzes user data and preferences to suggest personalized content, such as articles, videos, or products, in which a user is most likely to be interested based on their past interactions, behavior, and interests. These systems are employed to create a more tailored experience on, for example, a website, app or streaming service by looking at features like genre, keywords, or descriptions within the content itself.

### SUMMARY

In an example implementation, a current entity of interest is determined based on interaction data associated with a period of time. A next entity of interest and a transition timeframe is determined based on the current entity, the period of time, and a plurality of interest movement patterns. Each interest movement pattern of the plurality of interest movement patterns is associated with a respective entity pair and a respective transition time. The respective transition time and the respective entity pair being identified from user interaction histories. A recommended content item is generated based on the next entity of interest. The recommended content item is provided based on the likely transition timeframe.

It is appreciated that methods in accordance with the present disclosure can include any combination of the aspects and features described herein. That is, methods in accordance with the present disclosure are not limited to the combinations of aspects and features specifically described herein but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 depicts an example user activity sequence;

FIG. 2 depicts a number of interest movements;

FIG. 3 depicts an example environment that can be employed to execute implementations of the present disclosure;

FIG. 4 depict a flowchart of another non-limiting process that can be performed by implementations of the present disclosure; and

FIG. 5 depicts an example of a distributed computer device that can be used to implement the described techniques.

### DETAILED DESCRIPTION

With the explosion of content available on the internet, content recommendation systems are indispensable for filtering through vast amounts of information and presenting users with items most likely to engage them. These systems can be found in many applications, such as e-commerce platforms, news websites, social media feeds, video streaming services, and search engines. The content recommendation systems often employ algorithms that analyze user data (e.g., browser data) to suggest relevant content, such as articles, media (e.g., videos, music), products, or news, based on a user's past interactions, interests, and preferences, effectively tailoring the content provided a user's unique profile. In some cases, content recommendation systems are configured to analyze features of content, such as genre, keywords, and/or the author to identify similar items that a user might enjoy and act as a personalized filter for the user presenting the most appealing content options.

In some cases, the content recommendation system standardizes content and user data and removes irrelevant or noisy information, ensuring that meaningful patterns are identified. Key characteristics of both users and content such as user preferences (e.g., favorite topics or genres) and content attributes (e.g., keywords or categories) are identified via feature extraction of the relevant data. The content recommendation system must also be configured to account for user context, adjusting recommendations according to the user's current activity or environment.

Content recommendation systems employ recommendation techniques to determine how content is suggested to users. The two most commonly used methods are collaborative filtering and content-based filtering. With collaborative filtering, content is suggested based on the behavior of similar users. Specifically, user-based collaborative filtering includes recommending content items based on activities of similar user activities while item-based collaborative filtering includes recommending content similar to content with which the user has previously interacted (e.g., when a user watches a video based on a particular movie or streaming show, the system might suggest other videos related to similar movies or shows). Content-based filtering focuses more on the features of the content rather than user behavior. For example, content recommendation systems employing content-based filtering may suggest content based on similarity to material in which a user has already shown interest (e.g., if a user regularly reads articles about technology, the system may recommend other articles in that technology category using attributes such as keywords, tags, topics, and the like).

Hybrid content recommendation systems combine these methods to improve the quality of recommendations. By leveraging both collaborative filtering and content-based filtering, hybrid systems can overcome some of the weaknesses of each approach. For example, collaborative filtering may struggle with new items (the cold-start problem), but content-based filtering can still recommend content based on the content's features. Similarly, content-based filtering can be limited by the narrow scope of a user's history, while collaborative filtering provides a broader perspective.

In some implementations, content recommendation systems are configured to rank content based on, for example, relevance and/or engagement potential. In such cases, a ranking algorithm may be employed to assess the likelihood of user interaction. Other factors such as popularity, freshness, diversity, and novelty may also be considered. For instance, a recommendation system for a video streaming platform may prioritize new releases while also recommending popular videos related to the user's past interests.

A technical problem with content recommendation systems is the reliance on static user interest profiles derived from historical interaction data, such as search queries and content consumption patterns. These static profiles fail to capture the dynamic nature of user interests, leading to the repeated recommendation of content related to stale or obsolete interests. The result is low user engagement, limited discovery of novel content, and ultimately, a less satisfying user experience. To address the limitations of static profiles, some systems attempt to suggest related documents or queries based on current user activity. While such approaches offer some degree of personalization, they primarily focus on exploiting existing interests rather than actively exploring new ones, which can still lead to a repetitive user experience and limited discovery of novel content.

Accordingly, implementations of the described system are configured to analyze user interaction histories to build an understanding of global patterns of interest migration in populations (i.e., clusters) of users grouped based on a shared or similar characteristic(s) and/or interest. This information is then employed for content recommendation for a particular user. This analysis reveals not only patterns of how interests are broadly related but also how they are directly connected over time, providing a more precise understanding of user interest evolution. Implementations can use these dynamic patterns to predict the “next interest” for a user and recommend content accordingly. Moreover, by proactively guiding users toward these predicted areas of interest, systems continuously learn and adapt to a user's evolving preferences, thereby promoting the discovery of novel content and increasing user engagement.

In some cases, the described content recommendation system is configured to represent user activity as a sequence of interactions, where each interaction is associated with one or more “interest entities.” Interest entities may include, for example, concepts, topics, or items of interest relevant to the user's interactions. Clusters of relevant entities are identified based on an analysis of these interest entities. The transition time (i.e., the period of time) between the interaction with a source entity and the interaction with a destination entity are recorded. The movement of a user's interest to another interest is referred to herein as an “interest movement.” Interest movements may be grouped based on, for example, the respective source and destination entity combinations. In some cases, the transition times from each unique source-destination entity pair generate a distribution of transition times, referred to herein as “interest movement patterns.”

In some implementations, the described content recommendation system employs the distribution of transition times to predict a next interest for a user and reveal a transition timeframe for a user to shift their interest from the source to that next interest. This next interest is then used to proactively guide users toward predicted entities of interest in accordance with the typical time (so that a recommendation is not suggested prematurely). In some cases, the transition timeframe includes a probability scale indicating a likelihood of a transition from a current entity to the next entity. In some examples, a probability scale is a numerical line (e.g., ranging from zero to one) used to represent the likelihood of an event occurring, where a first number (e.g., zero) signifies an impossible event and a second number (e.g., one) signifies a certain event. The probability scale provides a probability of different events (e.g., a transition between entities of interest) using values representing varying degrees of a likelihood of an occurrence of the event.

These interest movement patterns also provide insights into user interest dynamics. For example, the distribution of transition times for patterns where the source and destination entities are the same, the distribution of transition times, which form the transition timeframes associated with the transition between entities, indicates how long users typically maintain interest in that specific entity while the distribution for patterns with different source and destination entities reveals the typical time that it takes for users to shift their interest from the source to the destination.

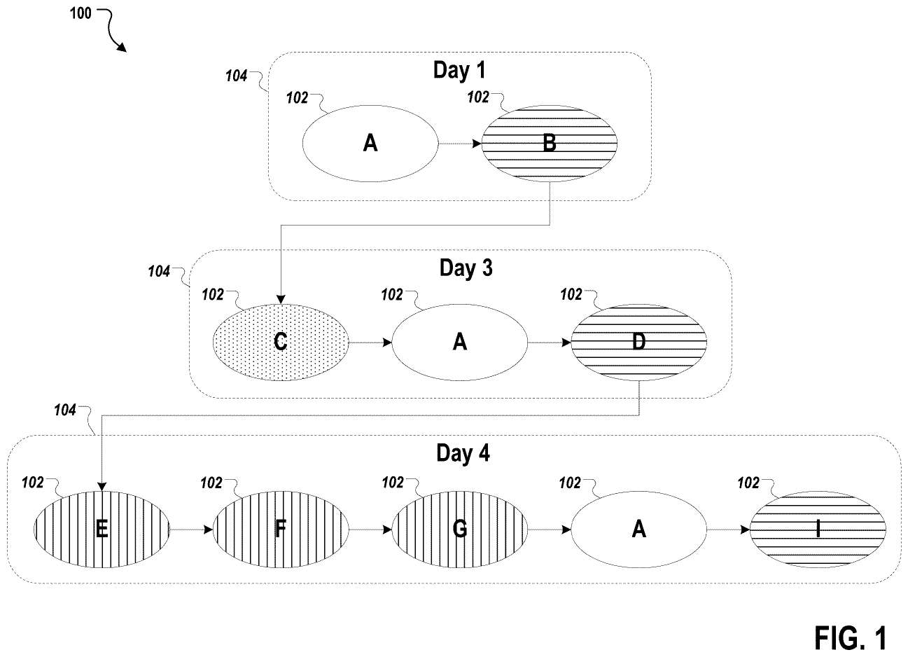

FIG. 1 depicts an example user activity sequence 100 that is associated with interest entities 102 tracked over a period of days 104. In some cases, the user activity is generated based on application data (e.g., browser data) associated with and/or collected via an application, such as a browser. In some cases and as depicted in FIG. 1, a user activity sequence 100 may be represented as a sequence of interactions, each associated with one or more interest entities 102.

These interest entities 102 represent concepts, topics, or items of interest relevant to the user's interaction. In some implementations, the described system is configured to perform a similarity analysis on the interest entities 102 to identify clusters of related entities. Entities with a high similarity are grouped together. In the user activity sequence 100, the interest entities B and D are grouped as well as the interest entities E, F, and G (these groupings of similar interest entities 102 are depicted in FIG. 1 according to the pattern overlay of each oval).

In some cases, a similarity analysis is based on a plurality of signals but not limited to these signals. Signals include pieces of information that the described system uses to determine the relevance and ranking of content to recommend to a user. These signals may include keywords on the page, backlinks from other websites, user engagement metrics, location data, and the quality of content, and the like. As an example, a search query and a web document may include a co-occurrence when a first interest entity and a second interest entity both appear in the search query and the web document. In such an example, the similarity analysis may be employed to determine the likelihood that both entities appear (e.g., “San Francisco” and “49ers”, “San Francisco” and “SF GATE”) in search queries and web documents respectively. Other example signals include broader interest entities (e.g., “San Francisco” and “California”), narrower interest entities (e.g., “San Francisco” and “Golden Gate Bridge”), sideway interest entities (e.g., “San Francisco” and “Los Angeles”), and the like. Generally, broader interest entities and narrower interest entities are broader or narrower in scope or context, respectively, as compared to the baseline entity whereas sideway interest entities have a similar scope or context. In some cases, a similarity analysis considers second degree connections using, for example, the above signals.

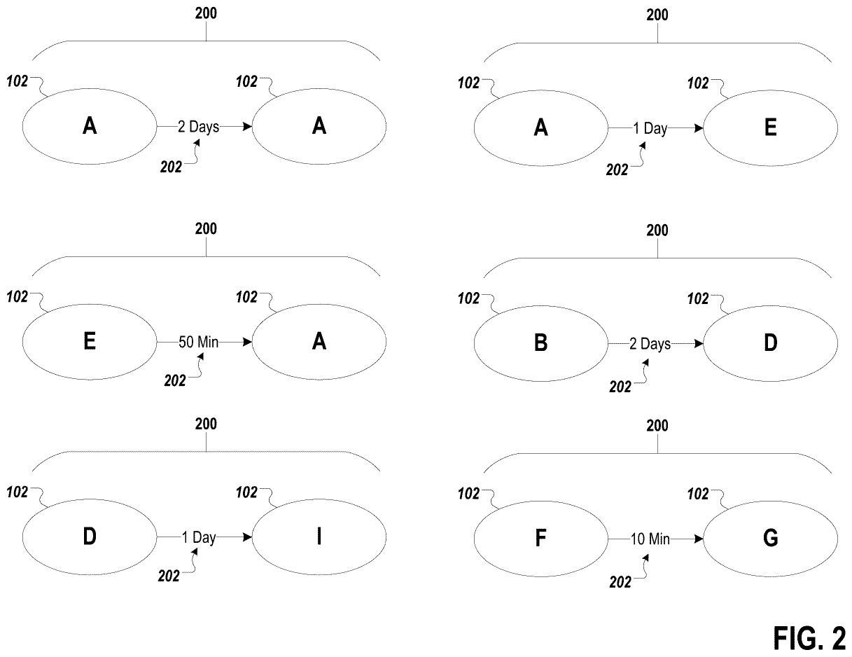

FIG. 2 depicts a number of interest movements 200. As used herein, an interest movement is a transition from a source interest entity 102 to a destination interest entity 102 within a user's activity sequence (e.g., the user activity sequence 100 described above with reference to FIG. 1). The time gap between the interaction with the source entity 102 and the interaction with the destination entity 102 is recorded as the transition time 202.

In some cases, an interest movement is considered valid when the source and destination are the same entity. For example, if a user reads “White House news” every day, the described system may be configured to log repeated entries for “White House news” at daily intervals. Conversely, if a user reads “White House news” continuously for an hour, even with multiple actions, the described system may be configured to log these interactions as a single event because the actions are part of the same uninterrupted activity.

Interest movements can be grouped based on the source and destination entity combinations (i.e., a source-destination pair). For example, the system is configured to generate a distribution of transition times (i.e., a transition timeframe) based on the transition times of corresponding interest movements collected for each unique source-destination pair. This distribution represents the interest movement pattern for that specific source-destination pair.

In some implementations, the system is configured to analyze the interest movement patterns to identify insights into user interest dynamics. For example, patterns where the source and destination entities are the same, the distribution of transition times indicates how long users typically maintain interest in that specific entity, while patterns with different source and destination entities reveal a typical time for users to shift their interest from the particular source to the particular destination. In some cases, additional data is collected from prior steps to enable an association of a partial population to the user.

In some cases, the interconnected nature of interest movements may be further visualized as a directed graph (e.g., a visualization of a Markov chain) that provides a comprehensive view of how user interests evolve over time and analyze the user's interest evolution pattern from a starting point. For example, each node in the directed graph may represent an interest entity and each directed edge an interest movement pattern. In some cases, the edges are annotated with the probability of transition (derived from the frequency of the pattern) and the expected duration of the transition (derived from the distribution of transition times).

In some cases, the user's current and priority interests are identified. As an example, entities [L, M, N] are identified as representing a user's key interests at present. In one example use case for product quality monitoring, the described system can be employed to track whether the user has already received recommendations for L, M, and N to then evaluate if a product is aligned with the user's current interests. As another use case, the describe system may be employed to access recommendation lists (e.g., whether a list included any of the user's high-priority interests, L, M, or N) to measure the relevance of generated recommendations. In yet another use case for engine improvement, the system employs the entities L, M, and N, as features to directly incorporate the user's current, high-priority interests into the recommendations provided.

### Example Environment

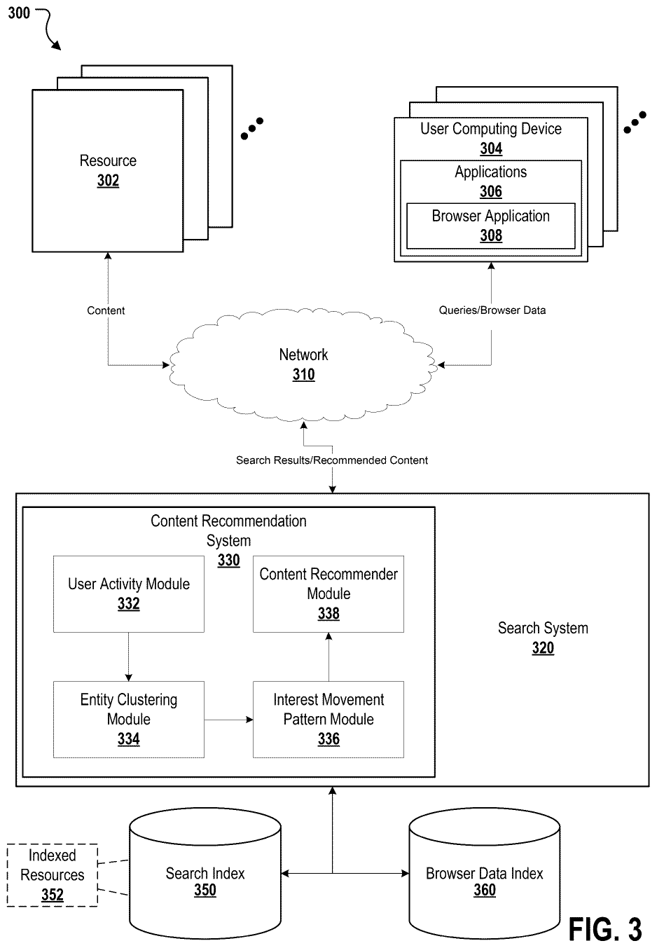

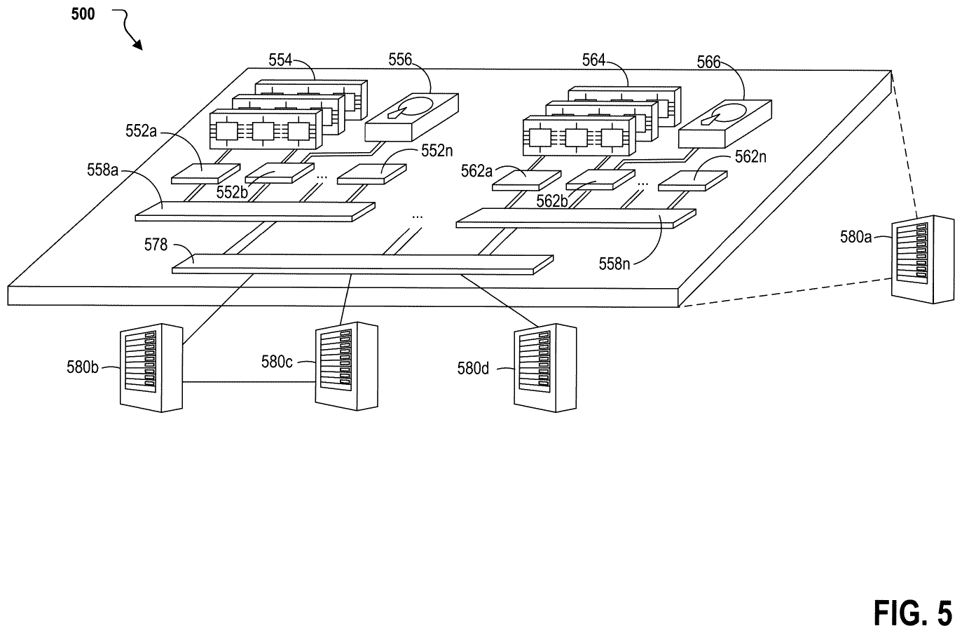

FIG. 3 is a block diagram of an example environment 300 in which users can interact with the described content recommendation system to receive content recommendations based on, for example, the user's browser data. The example environment 300 includes a search system 320 that includes a content recommendation system 330. The content recommendation system 330 includes user activity module 332, entity clustering module 334, interest movement pattern module 336, and content recommender module 338. As depicted, the example environment 300 also includes a communications network 310 that connects the search system 320, user computing devices 304, and resources 302. In some implementations, one or more of the systems 320 and 330 and modules 332, 334, 336 and 338 are executed via an electronic processor (e.g., processing units) configured to process instructions (e.g., modules, engines, models) stored in a memory, such as described below with reference to FIG. 5.

The communications network 310 may include wireless and wired portions that may be accessed over a wired and/or a wireless communications link. For example, user computing devices 304, such as smartphones can use a cellular network to access the network 310. The example environment 300 may include millions of resources 302 (e.g., provided via websites) and user computing devices 304. In some cases, the communications network 310 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 310 may also include future developed networks. In some implementations, the communications network 310 includes the Internet, an intranet, an extranet, or an intranet and/or extranet that is in communication with the Internet. In some implementations, the communications network 310 includes a telecommunication or a data network.

Resources 302 may include any content that is accessible, via an identifier, by a search engine. Resources 302 may include content, such as video content, provided by a server (e.g., a webserver). Thus, resources 302 may include web resources, documents, programming elements, and the like. Other example web resources include, but are not limited to, text, images files, video files, audio files, feed sources, and the like. In some cases, a resource 302 may include or link to a web resource (e.g., a web page) that provides data that can be accessed via the communications network 310 using a resource address (e.g., a uniform resource locator (URL)). In some cases, the web resources 302 are formatted in a markup language (e.g., hypertext markup language (HTML), extensible markup language (XML), and the like). In some cases, the resources 302 (e.g., web resources) include embedded information such as metadata information, hyperlinks, embedded instructions (e.g., scripts) and the like. In some cases, the resources 302 are published by a resource provider via a website. Such a website may include a collection of the resources 302.

In some cases, the search system 320 as well as publishers of some of the resources 302 are associated with a domain(s) and hosted by one or more servers in one or more locations. In some cases, these one or more servers include a server-class hardware type device and/or computer systems using clustered computers and components to function as a single pool of seamless resources when accessed through the communications network 310. For example, such implementations may be used in data center, cloud computing, storage area network (SAN), and network attached storage (NAS) applications. In some implementations, the one or more servers are deployed using a virtual machine(s).

In some implementations, user computing device(s) 304 is an electronic device capable of providing and receiving (e.g., a request) resources (e.g., media content) over the communications network 310. Example user computing devices 304 include personal computers, mobile communication devices, tablet computers, Extended Reality (XR) devices, and the like. The user computing devices 304 may include (e.g., may each include) any appropriate type of computing device, such as a desktop computer, a laptop computer, a handheld computer, a tablet computer, a personal digital assistant (PDA), an augmented reality (AR)/virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

Users of the user computing devices 304 may interact with a graphical user interface (GUI) or an application(s) 306, such as a client application, that is installed and executed on the user computing devices 304. Example client applications include a browser application 308. In some implementations, the browser application 308 is configured to communicate with resources 302 (e.g., web servers) via the communications network 310 to fetch and render content (e.g., web-based content). In some implementations, the browser application 308 provides the content via a display with which a user can interact. For example, the browser application 308 may be configured to display webpages, execute web applications, and the like.

In some implementations, the browser application 308 receives content by loading a native library, performing a domain name system (DNS) lookup based on a resource locator (e.g., a uniform resource locator (URL)) associated with a particular resource (e.g., a web service provided via a web server) and downloading the provided content. In some implementations, the browser application 308 includes a renderer for providing the received content to a user. For example, the browser application 308 may be configured to provide content via a browser tab of a browser window.

Through the use of the browser application 308, resources (such as web-based content) may provide a navigation bar, sitemap, dropdown menu, and the like to navigate resources within a domain. In some implementations, the browser application 308 includes tools to support navigation, such as bookmarks, browsing history, and the like. In some implementations, the browser application 308 defines forward and back buttons to navigate through previously viewed resources (e.g., web pages). In some implementations, the user computing device 304 is a mobile device and the browser application 308 is a mobile browser designed for use on the mobile device. In such implementations, the browser application 308 is configured to render and display web-based content in a mobile format (in addition to desktop format).

The browser application 308 may include additional functionality such as content recommended from the content recommendation system 330. In some implementations, the browser application 308 is configured to provide a query and browser data to the search system 320 and display recommended content along with the search results provided by the search system 320. As depicted, the content recommendation system 330 is executed via a server (e.g., as a provided web service) and is integrated with the search system 320. It is contemplated, however, that the content recommendation system 330 and/or elements of the content recommendation system 330 may be executed locally on the user computing devices 304 (e.g., integrated with the browser application 308 or as an independent application 306 with which the browser communicates) or as a service that is independent from the search system 320.

In some implementations, the search system 320 accesses a search index 350 to search resources 302. In some implementations, the search index 350 includes a datastore of resources 302 (indexed resources 352) generated by crawling the information (e.g., web sites) provided by the publisher of the resource 302. In some implementations, the search index 350 is a repository for persistently storing and managing collections of data. Example data stores, such as the search index 350, that may be employed within the described system include data repositories, such as a database as well as simpler store types, such as files, emails, and so forth. In some implementations, the search index 350 includes a database. In some implementations, a database is a series of bytes or an organized collection of data that is managed by a database management system (DBMS).

In some implementations, the content recommendation system 330 is configured to provide recommended content to a user computing device 304 (e.g., to the browser application 308) that is determined based on browser data, such as a browser history, and global patterns of interest migration in populations of users. In some implementations, the content recommendation system 330 analyzes historic browser data related to populations of users. In some cases, the historic browser data is collected from browser applications, such as browser application 308, executing on various user devices according to the permissions set by users of these devices and applications. In some cases, a portion or all of the historic browser data may be generated via a trained model. In some implementations, the historic browser data may be stored to a data store, such as the browser data index 360, for analysis by the content recommendation system 330. In some implementations, analysis of the historic browser data is performed offline.

As described above, the content recommendation system 330 analyzes the historic browser data to determine not only how interests are broadly related but also how they are directly connected over time to provide a more precise understanding of user interest evolution. In some implementations, the content recommendation system 330 employs these dynamic patterns to provide a next interest as well as content related to this interest to a user who is interacting with the computing device 304. In some cases, the content recommendation system 330 is configured to proactively guide users toward these determined areas of interest by continuously learning and adapting to a user's evolving preferences thereby promoting the discovery of novel content and increasing user engagement.

In some implementations, the user activity module 332 is configured to receive (e.g., via the communications network 310 when executing by a server as a web service or from a memory associated with the browser application 308 when executing locally on the user computing device 304) browser data, including browser history data, from the browser application 308. The user activity module 332 generates user activity sequences based on the browser data that represents a user's activity (i.e., user interaction histories) as a sequence of interactions. The entity clustering module 334 analyzes the user activity sequences and identifies clusters of relevant entities based on a similarity analysis of the user activity sequences as well as a plurality of signals included in the browser data. In some implementations, movement pattern module 336 then generates interest movement patterns from the user activity sequence and the clusters of relevant entities. As described above, the interest movement patterns provide insights in the distribution of transition times between interactions with source entities and destination entities.

In some implementations, the content recommender module 338 employs the distribution of transition times to predict a next interest for a user based on provided browser data. The content recommender module 338 is configured to provide content recommendations based on the predicted next interest and proactively guide users toward the predicted entities of interest in accordance with the typical time.

### Example Processes

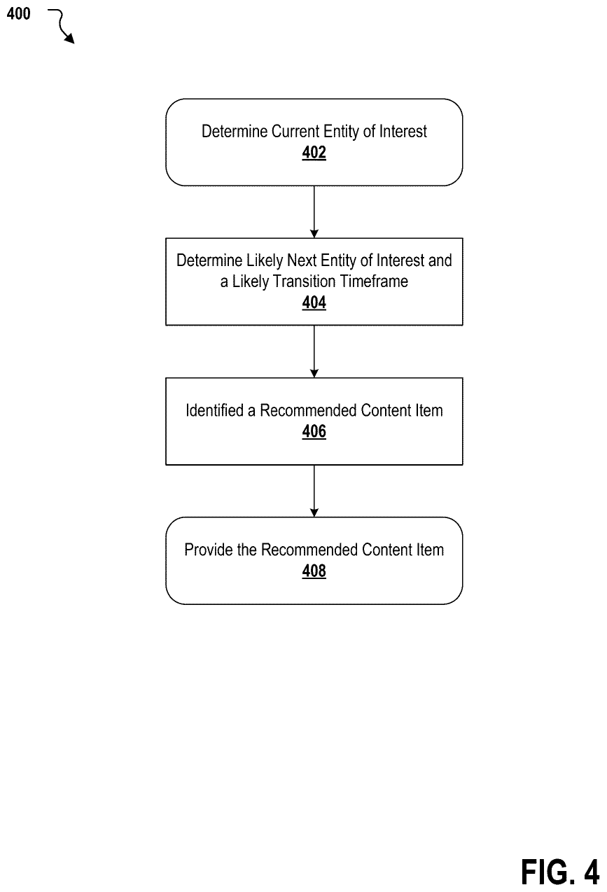

FIG. 4 depicts a flowchart of example process 400 that can be implemented by implementations of the present disclosure. The example process 400 can be implemented by systems and components described with reference to FIGS. 3 and 5. The example process 400 shows in more detail recommending a content item for a user based on interaction data (e.g., user interests identified in user interactions with the browser, collected with user consent).

For clarity of presentation, the description that follows generally describes the example process 400 in the context of FIGS. 1, 2, 3, and 5. However, it will be understood that the process 400 may be performed, for example, by any other suitable system, environment, software, and hardware, or a combination of systems, environments, software, and hardware as appropriate. In some implementations, various operations of the process 400 can be run in parallel, in combination, in loops, or in any order.

At 402, the content recommender module 338 receives browser data from the browser application 308 that includes information (i.e., interaction data) related to a user's interactions with various entities, such as content provided via the resources 302. The content recommender module 338 determines a current entity of interest for a user based on the interaction data that is associated with a period of time. In some cases, the interaction data includes a sequence of user interactions with at least one entity using the browser application 308. In some cases, the period of time is the period of the time of an engagement with the current entity of interest by a user associated with the interaction data.

From 402, the process proceeds to 404 where the content recommender module 338 is configured to determine a next entity of interest and a transition timeframe based on the current entity, the period of time, and a plurality of interest movement patterns provided by the interest movement pattern module 336. In some cases, the current entity or the next entity include a concept, a topic, or an item associated with the interaction data. In some cases, each interest movement pattern of the plurality of interest movement patterns is associated with a respective entity pair and a respective transition time. In some cases, the respective transition time and the respective entity pair being identified from user interaction histories. In some cases, the transition timeframe includes a probability scale indicating a likelihood of a transition from the current entity to the next entity.

In some cases, the content recommender module 338 is configured to determine the next entity of interest and the transition timeframe is determined based on the current entity, the plurality of interest movement patterns, and the interaction data. In some cases, the next entity of interest and the current entity of interest are a same entity of interest. In some cases, both entities included in the at least one entity pair associated with a respective interest movement pattern of the plurality of interest movement patterns are the same entity. In some cases, the at least one entity pair associated with a respective interest movement pattern of the plurality of interest movement patterns indicate repeated entries for the same entity of interest over a measured period of time.

As described above, the interest movement pattern module 336 is configured to determine the plurality of interest movement patterns based on the user activity sequences generated for the user interaction histories by user activity module 332 as well as the clusters relevant entities identified by the entity clustering module 334 based on an analysis of the user activity sequences. In some cases, the plurality of user interaction histories are associated with a population of users. In some cases, the user interaction histories include a plurality of web documents or a plurality of search.

From 404, the process 400 proceeds to 406 where the content recommender module 338 is configured to generate a recommended content item based on the next entity of interest.

From 406, the process 400 proceeds to 408 where the content recommender module 338 is configured to provide, via the content recommendation system 330, the recommended content item based on the transition timeframe. In some implementations, the content recommender module 338 is configured to provide the recommended content item to the browser application 308. In some implementations, the content recommender module 338 is configured to identify and provide additional recommended content items at an interval corresponding to the likelihood of the transition. From 408, the process 400 ends or repeats.

In some implementations, the content recommender module 338 is configured to determine the next entity of interest on a probability associated with each of a plurality of candidate next entities of interest as determined from the plurality of interest movement patterns.

### Example System

FIG. 5 shows an example of a computing device 500, which may be search system 320 and/or the content recommendation system 330 of FIG. 3, which may be used with the techniques described here. The example computing device 500 can be programmed or otherwise configured to implement systems or methods of the present disclosure. Computing device 500 is intended to represent various example forms of large-scale data processing devices, such as servers, blade servers, data centers, mainframes, and other large-scale computing devices. Computing device 500 may be a distributed system having multiple processors, possibly including network-attached storage nodes, that are interconnected by one or more communication networks. The components shown here, their connections and relationships, and their functions, are meant to be examples only, and are not meant to limit implementations of the implementations described and/or claimed in this document.

Computing device 500 may be a distributed system that includes any number of computing devices 580 (e.g., 580a, 580b, . . . 580n). Computing devices 580 may include a server or rack servers, mainframes, and the like, communicating over a local or wide-area network, dedicated optical links, modems, bridges, routers, switches, wired or wireless networks, and the like.

In some implementations, each computing device may include multiple racks. For example, computing device 580a includes multiple racks (e.g., 558a, 558b, . . . , 558n). Each rack may include one or more processors, such as processors 552a, 552b, . . . , 552n and 562a, 562b, . . . , 562n. The processors may include data processors, network attached storage devices, and other computer-controlled devices. In some implementations, one processor may operate as a master processor and control the scheduling and data distribution tasks. Processors may be interconnected through one or more rack switches 562a-562n, and one or more racks may be connected through switch 578. Switch 578 may handle communication between multiple connected computing devices 500.

Each rack may include memory, such as memory 554 and memory 564, and storage, such as 556 and 566. Storage 556 and 566 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 556 or 566 may be shared between multiple processors, multiple racks, or multiple computing devices and may include a non-transitory computer-readable medium storing instructions executable by one or more of the processors. Memory 554 and 564 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 554 may also be shared between processors 552a-552n. Data structures, such as an index, may be stored, for example, across storage 556 and memory 554. Computing device 500 may include other components not shown, such as controllers, buses, input/output devices, communications modules, and the like.

An entire system may be made up of multiple computing devices 500 communicating with each other. For example, device 580a may communicate with devices 580b, 580c, and 580d, and these may collectively be known as search system 320. Some of the computing devices may be located geographically close to each other, and others may be located geographically distant. The layout of computing device 500 is an example only and the system may take on other layouts or configurations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device, e.g., magnetic discs, optical disks, memory, Programmable Logic Devices (PLDs), used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, add-ons, or combinations thereof.

Further to the descriptions above, a user may be provided with controls allowing the user to make an election as to both if and when systems, programs, or features described herein may enable collection of user information, e.g., information about a user's social network, social actions, or activities, profession, a user's preferences, or a user's current location, and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained, such as to a city, ZIP code, or state level, so that a particular location of a user cannot be determined. Thus, the user may have control over what information is collected about the user, how that information is used, and what information is provided to the user.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
determining a current entity of interest based on interaction data associated with a period of time;
determining a next entity of interest and a transition timeframe based on the current entity, the period of time, and a plurality of interest movement patterns, wherein each interest movement pattern of the plurality of interest movement patterns is associated with a respective entity pair and a respective transition time, the respective transition time and the respective entity pair being identified from user interaction histories;
identifying a recommended content item based on the current entity of interest and the next entity of interest; and
providing the recommended content item based on the transition timeframe.

2. The method of claim 1, wherein the next entity of interest is determined based on a probability associated with each of a plurality of candidate next entities of interest as determined from the plurality of interest movement patterns.

3. The method of claim 1, wherein the plurality of interest movement patterns are determined by clustering entities based on a similarity analysis of a plurality of user activity sequences and a plurality of signals included in the user interaction histories.

4. The method of claim 1, wherein the transition timeframe includes a probability scale indicating a likelihood of a transition from the current entity to the next entity.

5. The method of claim 4, further comprising:
identifying and providing additional recommended content items at an interval corresponding to the likelihood of the transition.

6. The method of claim 1, further comprising:
determining the plurality of interest movement patterns by performing a similarity analysis of a plurality of entities included in the user interaction histories.

7. The method of claim 6, wherein the similarity analysis is based on a plurality of signals, the plurality of signals include co-occurrences of related entities in the plurality of entities, and
the user interaction histories include a plurality of web documents or a plurality of search queries.

8. The method of claim 1, wherein the next entity of interest and the current entity of interest are a same entity of interest when both entities from the respective entity pair associated with a particular interest movement pattern are the same entity.

9. The method of claim 8, wherein the respective entity pair associated with the particular interest movement pattern indicates repeated entries for the same entity of interest over a measured period of time.

10. The method of claim 1, wherein the interaction data includes a sequence of user interactions with at least one entity via a browser application, and
the period of time is the period of the time of engagement with the current entity of interest via the browser application.

11. The method of claim 1, wherein the current entity or the next entity include a concept, a topic, or an item associated with the interaction data.

12. The method of claim 1, wherein the interaction data includes browser data received from a browser, the method further comprising:
providing the recommended content item to the browser.

13. The method of claim 1, wherein the interaction data is associated with a user, and the user interaction histories are associated with a population of users.

14. A non-transitory computer-readable medium storing executable instructions that when executed by an electronic processor, cause the electronic processor to:
determine a current entity of interest based on interaction data associated with a period of time;
determine a next entity of interest and a transition timeframe based on the current entity, the period of time, and a plurality of interest movement patterns, wherein each interest movement pattern of the plurality of interest movement patterns is associated with a respective entity pair and a respective transition time, the respective transition time and the respective entity pair being identified from user interaction histories;
identify a recommended content item based on the current entity of interest and the next entity of interest; and
provide the recommended content item based on the transition timeframe.

15. The non-transitory computer-readable medium of claim 14, wherein the next entity of interest is determined based on a probability associated with each of a plurality of candidate next entities of interest as determined from the plurality of interest movement patterns.

16. The non-transitory computer-readable medium of claim 14, wherein the plurality of interest movement patterns are determined by clustering entities based on a similarity analysis of a plurality of user activity sequences and a plurality of signals included in the user interaction histories.

17. A system comprising:
an electronic processor; and
a memory communicably coupled to the electronic processor and storing instructions that, when executed by the electronic processor, cause the system to:
determine a current entity of interest based on interaction data associated with a period of time;
determine a next entity of interest and a transition timeframe based on the current entity, the period of time, and a plurality of interest movement patterns, wherein each interest movement pattern of the plurality of interest movement patterns is associated with a respective entity pair and a respective transition time, the respective transition time and the respective entity pair being identified from user interaction histories;
identify a recommended content item based on the current entity of interest and the next entity of interest; and
provide the recommended content item based on the transition timeframe.

18. The system of claim 17, wherein the transition timeframe includes a probability scale indicating a likelihood of a transition from the current entity to the next entity.

19. The system of claim 18, wherein the instructions, when executed by the electronic processor, further cause the system to:
identify and provide additional recommended content items at an interval corresponding to the likelihood of the transition.

20. The system of claim 17, wherein the next entity of interest and the current entity of interest are a same entity of interest when both entities from the respective entity pair associated with a particular interest movement pattern are the same entity, and
the respective entity pair associated with the particular interest movement pattern indicates repeated entries for the same entity of interest over a measured period of time.
